(19) United States
(12) Patent Application Publication
(10) Pub. No.: US 2016/0232897 A1
(43) Pub. Date: Aug. 11, 2016

(54) ADAPTING TIMEOUT VALUES BASED ON INPUT SCOPES

(71) Applicant: MICROSOFT TECHNOLOGY LICENSING, LLC, Redmond, WA (US)

(72) Inventors: Alexandre Pereira, Seattle, WA (US); Robert Joseph Disano, Seattle, WA (US); Aneetinder Chowdhry, Redmond, WA (US)

(21) Appl. No.: 15/015,921

(22) Filed: Feb. 4, 2016

Related U.S. Application Data
(60) Provisional application No. 62/112,954, filed on Feb. 6, 2015.

(51) Int. Cl. G10L 15/26; G10L 25/78; G10L 15/22

(52) U.S. Cl. CPC G10L 15/265; G10L 15/22; G10L 25/78; G10L 2015/223

(57) ABSTRACT

Systems, methods, and computer-readable storage media are provided for adapting timeout values based on varying input scopes associated with text boxes. An indication that dictation has been initiated in association with a text box is received. An input scope associated with the text box is identified, for instance, by identifying a tag associated with the text box that defines an input scope associated therewith. A timeout value associated with the identified input scope is identified and applied to the dictation such that the microphone automatically deactivates (i.e., without affirmative user interaction) following an amount of time associated with the timeout value in which no speech is detected. Longer timeout values may be associated with user activities that result in lengthy, thought-out segments of text (e.g., word processing document composition) than are associated with user activities that result in short and/or command-oriented segments of text (e.g., search query composition).

### CROSS-REFERENCE TO RELATED APPLICATIONS

This application claims priority to U.S. Provisional Patent Application No. 62/112,954 filed Feb. 6, 2015 and entitled “Adapting Timeout Values Based on Input Scores,” which application is hereby incorporated by reference as if set forth in its entirety herein.

### BACKGROUND

Systems and method for use in computing systems that employ voice and/or speech recognition programs are becoming increasingly popular, especially given the increasingly mobile environment in which users utilize computing devices. Speech and/or voice recognition programs permit users to provide inputs via voice commands, with those voice commands being transcribed into typewritten text for insertion into, for instance, word processing documents, search query input fields, text messaging fields, and the like.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, and computer-readable storage media are provided for adapting timeout values based on varying input scopes associated with text boxes. An indication that dictation has been initiated in association with a text box is received. Such indication, for example, may be received when a user actively turns on a microphone (or other listening device) associated with a user computing device on which the text box is displayed, or when a user simply begins speaking into a microphone that is in a stand-by mode or the like, such that the microphone is automatically activated upon detection of speech initiation. An input scope associated with the text box is identified, for instance, by identifying a tag associated with the text box that defines an input scope associated therewith. A timeout value associated with the identified input scope is identified and applied to the dictation such that the microphone deactivates following an amount of time associated with the timeout value in which no speech is detected. Longer timeout values are generally associated with user activities that result in lengthy, thought-out segments of text (e.g., word processing documents) than are associated with user activities that result in short and/or command-oriented segments of text (e.g., search query composition)

The adaptive timeout feature of the present technology permits faster and more efficient processing as resources utilized in maintaining activation of a microphone until affirmative deactivation or the like may be reallocated in a timelier manner. The adaptive timeout feature further permits power to be saved which has become increasingly important to users as mobile, battery-operated computing devices have become more prevalent. Such advantages may be realized in accordance herewith while maintaining a positive user experience as adaptive timeout values decrease the probability that a user will be cut-off mid-utterance causing them to repeat already spoken words and/or manually reactivate the microphone, both of which can lead to user dissatisfaction with the dictation experience.

### BRIEF DESCRIPTION OF THE DRAWINGS

The present technology is illustrated by way of example and not limitation in the accompanying figures in which like reference numerals indicate similar elements and in which:

FIG. 1 is a block diagram of an exemplary computing environment suitable for use in implementing embodiments of the present technology;

FIG. 2 is a block diagram of an exemplary computing system in which embodiments of the technology may be employed;

FIG. 3 is a flow diagram showing an exemplary method for adapting timeout values based on varying input scopes associated with text boxes, in accordance with an embodiment of the present technology;

FIG. 4 is a flow diagram showing another exemplary method for adapting timeout values based on varying input scopes associated with text boxes, in accordance with an embodiment of the present technology; and

FIG. 5 is a flow diagram showing yet another exemplary method for adapting timeout values based on varying input scopes associated with text boxes, in accordance with an embodiment of the present technology.

### DETAILED DESCRIPTION

The subject matter of the present technology is described with specificity herein to meet statutory requirements. However, the description itself is not intended to limit the scope of this patent application. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for adapting timeout values based on varying input scopes associated with text boxes. An indication that dictation has been initiated in association with a text box is received. The text box may be associated with any of various programs or applications including, by way of example only, word processing programs, email programs, text messaging applications, SMS messaging applications, search applications, contact information applications (e.g., telephone and/or address maintenance and recall applications), and the like. The term “text box” is used broadly herein to include any region of an application or document configured to receive alphanumeric and/or textual input. For example, in a word processing application, a text box may include an entire document, a page or portion of a document, a rectangular or other shaped widget, or the like. The indication that dictation has been initiated, for example, may be received when a user actively turns on a microphone (or other listening device) associated with a user computing device on which the text box is displayed, or when a user simply begins speaking into a microphone that is in a stand-by mode or the like, such that the microphone is automatically activated upon detection of speech initiation. An input scope associated with the text box is identified, for instance, by identifying a tag associated with the text box that defines an input scope associated therewith. A timeout value associated with the identified input scope is identified and applied to the dictation such that the microphone automatically deactivates (i.e., without affirmative user interaction) following an amount of time associated with the timeout value in which no speech is detected. In embodiments, longer timeout values may be associated with user activities that result in lengthy, thought-out segments of text (e.g., word processing document composition) than are associated with user activities that result in short and/or command-oriented segments of text (e.g., search query composition).

The adaptive timeout feature of the present technology permits faster and more efficient processing as resources utilized in maintaining activation of a microphone until affirmative deactivation or the like may be reallocated in a timelier manner. The adaptive timeout feature further permits power to be saved which has become increasingly important to users as mobile, battery-operated computing devices have become more prevalent. Such advantages may be realized in accordance herewith while maintaining a positive user experience as adaptive timeout values decrease the probability that a user will be cut-off mid-utterance causing them to repeat already spoken words and/or manually reactivate the microphone, both of which can lead to user dissatisfaction with the dictation experience.

Accordingly, one embodiment of the present technology is directed to a method being performed by one or more computing devices including at least one processor, the method for adapting timeout values based on varying input scopes associated with text boxes. The method includes receiving an indication that dictation has been initiated in association with a text box, identifying an input scope associated with the text box, and adapting a timeout value for receipt of the dictation based upon the determined input scope.

In another embodiment, the present technology is directed to a system for adapting timeout values based on varying input scopes associated with text boxes. The system includes an adaptive timeout value application engine having one or more processors and one or more computer-readable storage media, and a data store coupled with the adaptive timeout value application engine. The adaptive timeout value application engine is configured to receive an indication that dictation has been initiated in association with a text box; determine that the text box has a tag associated therewith, the tag defining an input scope associated with the text box; identify a timeout value associated with the input scope; and apply the timeout value to the dictation.

In yet another embodiment, the present technology is directed to one or more computer-readable storage media storing computer-useable instructions that, when used by one or more computing devices, cause the one or more computing devices to perform a method for adapting timeout values based on varying input scopes associated with text boxes. The method includes receiving an indication that dictation has been initiated in association with a text box, determining that the text box has a tag associated therewith, the tag defining an input scope associated with the text box, identifying a timeout value associated with the input scope, determining that the timeout value has been satisfied, and deactivating a microphone associated with receipt of the dictation.

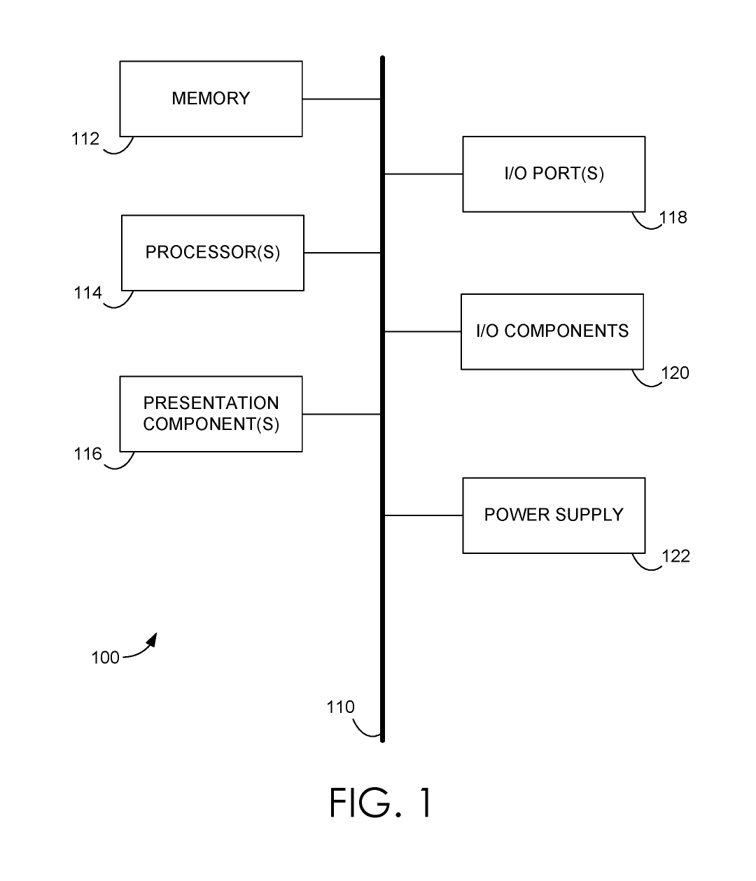

Having briefly described an overview of embodiments of the present technology, an exemplary operating environment in which embodiments of the present technology may be implemented is described below in order to provide a general context for various aspects of the present technology. Referring to the figures in general and initially to FIG. 1 in particular, an exemplary operating environment for implementing embodiments of the present technology is shown and designated generally as computing device 100. The computing device 100 is but one example of a suitable computing environment and is not intended to suggest any limitation as to the scope of use or functionality of embodiments of the technology. Neither should the computing device 100 be interpreted as having any dependency or requirement relating to any one component nor any combination of components illustrated.

Embodiments of the technology may be described in the general context of computer code or machine-useable instructions, including computer-useable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data types. Embodiments of the technology may be practiced in a variety of system configurations, including, but not limited to, hand-held devices, consumer electronics, general-purpose computers, more specialty computing devices, and the like. Embodiments of the technology also may be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components include a microphone, joystick, game pad, satellite dish, scanner, printer, wireless device, a controller, such as a stylus, a keyboard and a mouse, a natural user interface (NUI), and the like.

A NUI processes air gestures, voice, or other physiological inputs generated by a user. These inputs may be interpreted as dictation to be converted to typewritten text and presented by the computing device 100. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes may be provided to the display of the computing device 100 to render immersive augmented reality or virtual reality.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices. The computer-useable instructions form an interface to allow a computer to react according to a source of input. The instructions cooperate with other code segments to initiate a variety of tasks in response to data received in conjunction with the source of the received data.

Furthermore, although the term “adaptive timeout value application engine” is used herein, it will be recognized that this term may also encompass a server, web browser, sets of one or more processes distributed on one or more computers, one or more stand-alone storage devices, sets of one or more other computing or storage devices, any combination of one or more of the above, and the like.

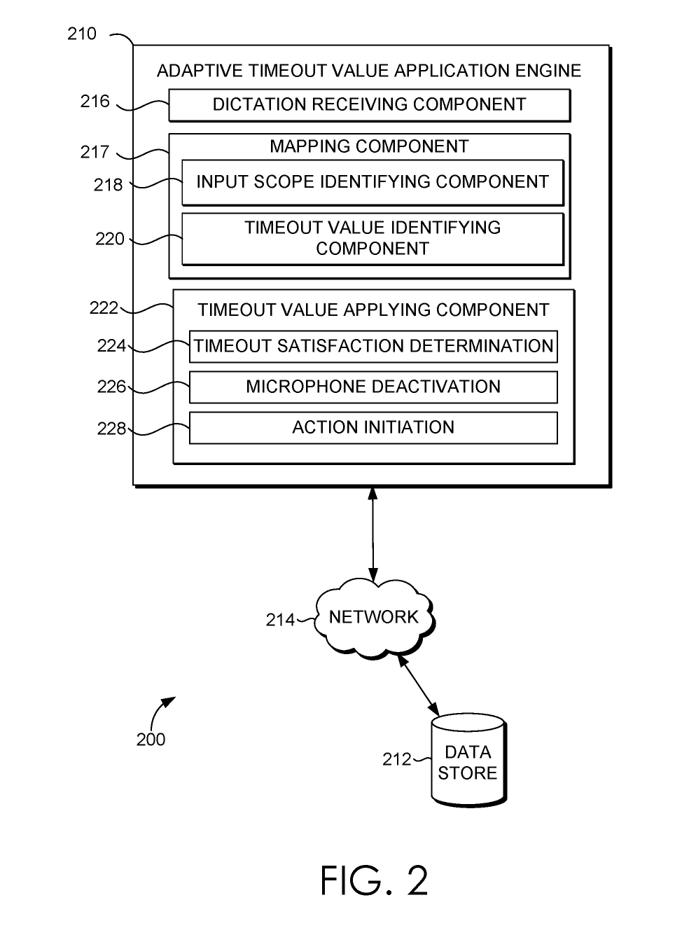

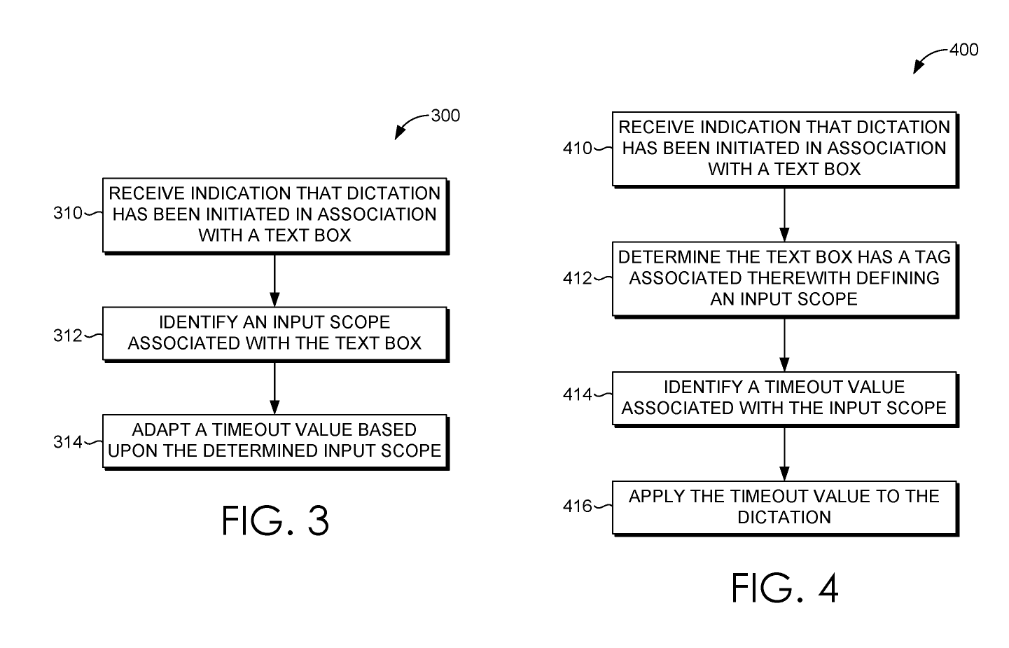

As previously set forth, embodiments of the present technology provide systems, methods, and computer-readable storage media for adapting dictation timeout values based upon an input scope associated with a text box in association with which the dictation is received. With reference to FIG. 2, a block diagram is provided illustrating an exemplary computing system 200 in which embodiments of the present technology may be employed. Generally, the computing system 200 illustrates an environment in which timeout values for dictation may be adapted based on varying input scopes associated with text boxes, in accordance with the methods, for instance, illustrated in FIGS. 3, 4 and 5 (more fully described below). Among other components not shown, the computing system 200 generally includes an adaptive timeout value application engine 210 and a data store 212 accessible by the adaptive timeout value application engine 210 via a network 214. The network 214 may include, without limitation, one or more local area networks (LANs) and/or wide area networks (WANs). Such networking environments are commonplace in offices, enterprise-wide computer networks, intranets and the Internet. Accordingly, the network 214 is not further described herein.

It should be understood that any number of adaptive timeout value application engines 210 may be employed in the computing system 200 within the scope of embodiments of the present technology. Each may comprise a single device/interface or multiple devices/interfaces cooperating in a distributed environment. For instance, the adaptive timeout value application engine 210 may comprise multiple devices and/or modules arranged in a distributed environment that collectively provide the functionality of the adaptive timeout value application engine 210 described herein. Additionally, other components or modules not shown also may be included within the computing system 200.

In some embodiments, one or more of the illustrated components/modules may be implemented as stand-alone applications. In other embodiments, one or more of the illustrated components/modules may be implemented via the adaptive timeout value application engine 210 or as an Internet-based service. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of adaptive timeout value application engines 210. By way of example only, the adaptive timeout value application engine 210 might be provided as a single computing device, a cluster of computing devices, or a computing device remote from one or more of the remaining components.

It should be understood that this and other arrangements described herein are set forth only as examples. Other arrangements and elements (e.g., machines, interfaces, functions, orders, and groupings of functions) can be used in addition to or instead of those shown and/or described, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

A computing device associated with the adaptive timeout value application engine 210 may include any type of computing device, such as the computing device 100 described with reference to FIG. 1, for example. Generally, a computing device associated with the adaptive timeout value application engine 210 also is associated with a microphone for accepting dictated input and one or more I/O components, such as a stylus or keypad, for permitting alpha-numeric and/or textual input into a designated region (e.g., text box). It should be noted that the functionality described herein as being performed by the adaptive timeout value application engine 210 may be performed by any other application, application software, user interface, or the like capable of accepting speech input and rendering typewritten text converted from such speech input. It should further be noted that embodiments of the present technology are equally applicable to mobile computing devices and devices accepting gesture, touch and/or voice input. Any and all such variations, and any combination thereof, are contemplated to be within the scope of embodiments of the present technology.

The adaptive timeout value application engine 210 of the computing system 200 of FIG. 2 is configured to, among other things, adapt timeout values for dictation based on input scopes. As illustrated, the adaptive timeout value application engine 210 has access to a data store 212. The data store 212 is configured to store information related to at least one of look-up tables identifying one or more of tags associated with various text boxes that define input scopes associated therewith, and timeout values associated with various input scopes; user behavior patterns (collective and user-specific) as they relate to particular user activities; and the like. To the extent user behavior patterns and the like that are specific to one or more users are stored in association with the data store 212, such user(s) may be permitted to consent to such data collection, in accordance with embodiments hereof. For instance, prior to collection of user-specific data, notice may be provided informing the user that such data will be collected unless s/he opts out of such collection. Alternatively, the user may be asked to take affirmative action to consent to collection (i.e., to opt-in) before such data is collected. Any and all such variations, and any combination thereof, are contemplated to be within the scope of embodiments of the present technology.

In embodiments, the data store 212 is configured to be searchable for one or more of the items stored in association therewith. It will be understood and appreciated by those of ordinary skill in the art that the information stored in association with the data store may be configurable and may include any information relevant to, by way of example only, text box tags, various input scopes, timeout values associated with text boxes, input scopes and/or tags, and the like. The content and volume of such information are not intended to limit the scope of embodiments of the present technology in any way. Further, the data store 212 may be a single, independent component (as shown) or a plurality of storage devices, for instance a database cluster, portions of which may reside in association with the adaptive timeout value application engine 210, another external computing device (not shown), and/or any combination thereof.

As illustrated, the adaptive timeout value application engine 210 includes a dictation receiving component 216, a mapping component 217, and a timeout value applying component 222. The dictation receiving component 216 is configured to, among other things, receive an indication that dictation has been initiated in association with a text box. Such indication may be received, for example, when a user actively turns on a microphone (or other listening device) associated with a user computing device on which the text box is displayed, or when a user simply begins speaking into a microphone that is in a stand-by mode or the like, such that the microphone is automatically activated upon detection of speech initiation. The text box may be associated with any of various programs or applications including, by way of example only, word processing programs, email programs, text messaging applications, SMS messaging applications, search applications, contact information applications (e.g., telephone and/or address maintenance and recall applications), and the like.

The mapping component 217 is configured to, among other things, map tags that define input scopes associated with text boxes to appropriate adaptive timeout values. In this regard, the mapping component 217 includes an input scope identifying component 218 and a timeout value identifying component 220. The input scope identifying component is configured to identify an input scope associated with a text box. In embodiments, such identification may be accomplished by determining that the text box has a tag associated therewith, the tag defining an input scope associated with the text box. Generally, input scopes associated with text boxes and/or tags may be identified by querying a look-up table associated with the data store 212 where such information is stored. Input scopes may be defined based upon any desired factor including, by way of example only, a likely user activity associated with the text box. For instance, an input scope associated with a text box in a word processing application may be tagged or otherwise identified as “document composition in excess of 100 words.” By way of another example, an input scope associated with a text box in a search application may be tagged or otherwise identified as “query composition, less than 20 words, command-oriented.” By way of yet another example, an input scope associated with a contact information application (e.g., a telephone and/or maintenance and recall application) may be tagged or otherwise identified as “contact composition, less than 20 words, sentence fragments likely.” If a text box does not have a tag associated therewith, an input scope may be determined based on one or more characteristics of the text box, including a number of characters or words to which the text box is restricted, textual or other guidance associated with the text box (e.g., text, an icon, or another indicator designating the type of data to be entered), an application with which the text box is associated, and the like. In other embodiments, a default input scope may be used when a text box does not have a tag associated therewith.

The timeout value identifying component 220 is configured to identify a timeout value associated with an identified input scope. Generally, such timeout values may be identified by querying a look-up table associated with the data store 212. Timeout values are generally adapted in accordance with the identified input scope. For instance, longer timeout values may be associated with user activities and/or input scopes that result in lengthy, thought-out segments of text (e.g., word processing document composition) than are associated with user activities and/or input scopes that result in short and/or command-oriented segments of text (e.g., search query composition). By way of example, a timeout value associated with a text box having an input scope for receipt of a search query may be approximately three seconds, while a timeout value associated with a text box having an input scope for receipt of a word processing document may be an order of magnitude larger, such as approximately thirty seconds. By way of another example, a timeout value associated with the a text box having an input scope for receiving an email contact may be approximately three seconds, while the timeout value for a text box having an input scope for receiving the text of an email message may be approximately ten seconds. In embodiments, the timeout values may be absolute values or offsets from a default value. In embodiments, the timeout values are predetermined to be associated with an identified input scope.

The timeout value applying component 222 is configured to apply the determined timeout value to the dictation. As illustrated, the timeout value applying component 222 includes a timeout satisfaction determination component 224, a microphone deactivation component 226 and an action initiation component 228. The timeout satisfaction determination component 224 is configured to determine that a period of time defined by a determined timeout value has been satisfied by the absence of any dictation being received for the specified time period. The microphone deactivation component 226 is configured to automatically deactivate a microphone associated with receipt of the dictation upon determining that the time period defined by the timeout value has been satisfied. In embodiments, such automatic deactivation requires no affirmative user interaction (e.g., the user does not need to manually deactivate the microphone).

In embodiments, upon microphone deactivation, an action may be automatically initiated by the action initiation component 228. For instance, the action initiation component 228 may automatically convert the speech into typewritten text in association with the text box upon deactivation of the microphone. By way of another example, the action initiation component 228 may submit a search query upon deactivation of the microphone where the input scope has been determined to be “search query composition.” Any and all such variations, and any combination thereof, are contemplated to be within the scope of embodiments of the present technology.

Turning now to FIG. 3, a flow diagram is illustrated showing an exemplary method 300 for adapting timeout values based upon varying input scopes associated with text boxes. As indicated at block 310, an indication that dictation has been initiated in association with a text box is received, e.g., by the dictation receiving component 216 of the adaptive timeout value application engine 210 of FIG. 2. As previously set forth, such indication may be received, for example, when a user actively turns on a microphone associated with a user computing device on which the text box is displayed, or when a user simply begins speaking into a microphone that is in a stand-by mode or the like such that it is automatically activated upon detection of speech initiation.

As indicated at block 312, an input scope associated with the text box is identified, for instance, by the input scope identifying component 218 of the mapping component 217 of the adaptive timeout value application engine 210 of FIG. 2. Such input scope may be identified, e.g., by querying a look-up table associated with a data store (e.g., the data store 212 of FIG. 2). As indicated at block 314, a timeout value for receipt of the speech is adapted based upon the determined input scope. In embodiments, longer timeout values may be associated with user activities and/or input scopes that result in lengthy, thought-out segments of text (e.g., word processing document composition) than are associated with user activities and/or input scopes that result in short and/or command-oriented segments of text (e.g., search query composition).

With reference now to FIG. 4, a flow diagram is illustrated showing another exemplary method 400 for adapting timeout values based upon varying input scopes associated with text boxes. As indicated at block 410, an indication that dictation has been initiated in association with a text box is received, e.g., by the dictation receiving component 216 of the adaptive timeout value application engine 210 of FIG. 2. As previously set forth, such indication may be received, for example, when a user actively turns on a microphone associated with a user computing device on which the text box is displayed, or when a user simply begins speaking into a microphone that is in a stand-by mode or the like such that it is automatically activated upon detection of speech initiation.

As indicated at block 412, it is determined (e.g., by the input scope identifying component 218 of the mapping component 217 of FIG. 2) that the text box has a tag associated therewith, the tag defining an input scope associated with the text box. As indicated at block 414, a timeout value associated with the input scope is determined, for instance, by querying a look-up table associated with a data store (e.g., the data store 212 of FIG. 2). Such determination may be made, for instance, by the timeout value identifying component 220 of the mapping component 217 of the adaptive timeout value application engine 210 of FIG. 2. As indicated at block 416, the timeout value is applied to the dictation (for instance, by the timeout value applying component 222 of the adaptive timeout value application engine 210 of FIG. 2). Such application may result, for instance, in deactivation of a microphone associated with receipt of the dictation as the time period associated with the timeout value is satisfied.

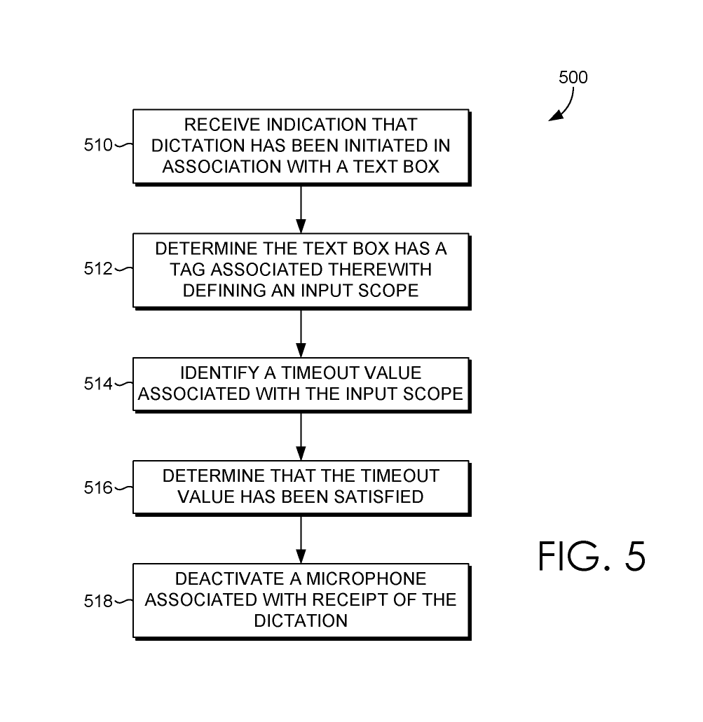

Turning now to FIG. 5, a flow diagram is illustrated showing another exemplary method 500 for adapting timeout values based upon varying input scopes associated with text boxes. As indicated at block 510, an indication that dictation has been initiated in association with a text box is received, e.g., by the dictation receiving component 216 of the adaptive timeout value application engine 210 of FIG. 2. Such indication may be received, for example, when a user actively turns on a microphone associated with a user computing device on which the text box is displayed, or when a user simply begins speaking into a microphone that is in a stand-by mode or the like such that it is automatically activated upon detection of speech initiation.

As indicated at block 512, it is determined (e.g., by the input scope identifying component 218 of the mapping component 217 FIG. 2) that the text box has a tag associated therewith, the tag defining an input scope associated with the text box. As indicated at block 514, a timeout value associated with the input scope is determined, for instance, by querying a look-up table associated with a data store (e.g., the data store 212 of FIG. 2). Such determination may be made, for instance, by the timeout value identifying component 220 of the mapping component 217 of the adaptive timeout value application engine 210 of FIG. 2. As indicated at block 516, it is determined that a time period associated with the timeout value has been satisfied, for instance, utilizing the timeout satisfaction determination component 224 of the timeout value applying component 222 of FIG. 2. A microphone associated with receipt of the dictation is deactivated, e.g., by the microphone deactivation component 226 of the timeout value applying component 222 of FIG. 2. In embodiments, such deactivation is automatic in that it is without affirmative user interaction.

As can be understood, embodiments of the present technology provide systems, methods, and computer-readable storage media for, among other things, adapting timeout values based on varying input scopes associated with text boxes. An indication that dictation has been initiated in association with a text box is received. Such indication, for example, may be received when a user actively turns on a microphone associated with a user computing device on which the text box is displayed, or when a user simply begins speaking into a microphone that is in a stand-by mode or the like, such that the microphone is automatically activated upon detection of speech initiation. An input scope associated with the text box is identified, for instance, by identifying a tag associated with the text box that defines an input scope associated therewith. A timeout value associated with the identified input scope is identified and applied to the dictation such that the microphone automatically deactivates following an amount of time associated with the timeout value in which no speech is detected. In embodiments, longer timeout values may be associated with user activities that result in lengthy, thought-out segments of text than are associated with user activities that result in short and/or command-oriented segments of text.

The present technology has been described in relation to particular embodiments, which are intended in all respects to be illustrative rather than restrictive. Alternative embodiments will become apparent to those of ordinary skill in the art to which the present technology pertains without departing from its scope.

While the technology is susceptible to various modifications and alternative constructions, certain illustrated embodiments thereof are shown in the drawings and have been described above in detail. It should be understood, however, that there is no intention to limit the technology to the specific forms disclosed, but on the contrary, the intention is to cover all modifications, alternative constructions, and equivalents falling within the spirit and scope of the technology.

It will be understood by those of ordinary skill in the art that the order of steps shown in the methods 300 of FIG. 3, 400 of FIG. 4 and 500 of FIG. 5 is not meant to limit the scope of the present technology in any way and, in fact, the steps may occur in a variety of different sequences within embodiments hereof. Any and all such variations, and any combination thereof, are contemplated to be within the scope of embodiments of the present technology.

What is claimed is:

1. A method being performed by one or more computing devices including at least one processor, the method for adapting timeout values based on varying input scopes associated with text boxes, the method comprising:
receiving an indication that dictation has been initiated in association with a text box;
identifying an input scope associated with the text box; and
adapting a timeout value for receipt of the dictation based upon the determined input scope.

2. The method of claim 1, further comprising:
determining that the timeout value has been satisfied; and
deactivating a microphone associated with receipt of the dictation.

3. The method of claim 2, wherein the microphone is automatically deactivated in the absence of affirmative user action within a time frame defined by the timeout value.

4. The method of claim 1, wherein the timeout value is predetermined to be associated with the determined input scope.

5. The method of claim 1, wherein the input scope is based, at least in part, on a likely user activity associated with the text box.

6. The method of claim 5, wherein the likely user activity associated with the text box on which the input scope is based includes one of word processing document composition, email composition, text message composition, SMS message composition, search query composition, and contact information composition.

7. The method of claim 6, further comprising adapting the timeout value associated with the input scope based on at least one of collective behavior of a plurality of users or user-specific behavior, as observed with respect to the likely user activity.

8. A system comprising:
an adaptive timeout value application engine having one or more processors and one or more computer-readable storage media; and
a data store coupled with the adaptive timeout value application engine,
wherein the adaptive timeout value application engine:
receives an indication that dictation has been initiated in association with a text box;
determines that the text box has a tag associated therewith, the tag defining an input scope associated with the text box;
identifies a timeout value associated with the input scope; and
applies the timeout value to the dictation.

9. The system of claim 8, wherein the adaptive timeout value application engine applies the timeout value to the dictation by:
determining that the timeout value has been satisfied; and
deactivating a microphone associated with receipt of the dictation.

10. The system of claim 9, wherein the microphone is automatically deactivated in the absence of affirmative user action within a time frame defined by the timeout value.

11. The system of claim 8, wherein the timeout value is predetermined to be associated with the determined input scope.

12. The system of claim 8, wherein the input scope is based, at least in part, on a likely user activity associated with the text box.

13. The system of claim 12, wherein the likely user activity associated with the text box on which the input scope is based includes one of word processing document composition, email composition, text message composition, SMS message composition, search query composition, and contact information composition.

14. The system of claim 13, wherein the adaptive timeout value application engine further adapts the input scope based on at least one of collective behavior of a plurality of users or user-specific behavior, as observed with respect to the likely user activity.

15. One or more computer-readable storage media storing computer-useable instructions that, when used by one or more computing devices, cause the one or more computing devices to perform a method for adapting timeout values based on varying input scopes associated with text boxes, the method comprising:
receiving an indication that dictation has been initiated in association with a text box;
determining that the text box has a tag associated therewith, the tag defining an input scope associated with the text box;
identifying a timeout value associated with the input scope;
determining that the timeout value has been satisfied; and
deactivating a microphone associated with receipt of the dictation.

16. The one or more computer-readable storage media of claim 15, wherein the microphone is automatically deactivated in the absence of affirmative user action within a time frame defined by the timeout value.

17. The one or more computer-readable storage media of claim 15, wherein the timeout value is predetermined to be associated with the determined input scope.

18. The one or more computer-readable storage media of claim 15, wherein the input scope is based, at least in part, on a likely user activity associated with the text box.

19. The one or more computer-readable storage media of claim 18, wherein the likely user activity associated with the text box on which the input scope is based includes one of word processing document composition, email composition, text message composition, SMS message composition, search query composition, and contact information composition.

20. The one or more computer-readable storage media of claim 19, wherein the method further comprises adapting the timeout value associated with the input scope based on at least one of collective behavior of a plurality of users or user-specific behavior, as observed with respect to the likely user activity.
